(19) United States
(12) Patent Application Publication
(10) Pub. No.: US 2012/0159325 A1
(43) Pub. Date: Jun. 21, 2012

(54) Delayed Progress Meter for Long Running Tasks in Web Applications

(75) Inventors: Jeremy M. Stevens, Seattle, WA (US); Barnabas J. Whitfield, Kirkland, WA (US); Marcus A. Barry, Seattle, WA (US)

(73) Assignee: Microsoft Corporation, Redmond, WA (US)

(21) Appl. No.: 12/968,609

(22) Filed: Dec. 15, 2010

(51) Int. Cl. G06F 3/048; G06F 3/00

(52) U.S. Cl. 715/710; 715/772; 715/760

(57) ABSTRACT

In a user interface for editing electronic documents, the display of a progress meter may be delayed for long running tasks (such as the loading of an electronic document into a web browser). The user interface may include a control surface and a browser window for displaying electronic documents. A request to load an electronic document may be received in the browser window. The electronic document may then begin loading for display in the browser window. During the initial loading of the electronic document, a loading indicator may be displayed in the browser window. After a predetermined delay and while the document is still being loaded, the loading indicator may be replaced with a progress meter indicating a current loading percentage of the electronic document. The progress meter may be periodically updated during the remainder of the loading process until the entire electronic document has finished loading into the browser window.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Web-based software applications enable users to retrieve, view and edit electronic documents which may be stored in a distributed computing network, such as the Internet, in a web browser on a local client computer. With some electronic documents, long running processes are required in order to retrieve them for viewing in a web browser. As a result, it may be difficult for an end user to know when an operation (such as the loading of an electronic document in the user's web browser) will finish, or even obtain a current status of the operation with respect to completion. For example, an electronic document that is particularly long or complex may require an extended time period to load before it is ready to be viewed and or edited in a user's browser. However, with no feedback provided to the user during the loading process, the user may prematurely stop or restart the loading process before it has reached completion. Furthermore, viewing and editing certain long or complex electronic documents in a web browser may not provide an optimal experience for some users. For example, long or complex electronic documents which require application functionality not available in a browser or which require long performing operations may diminish the general user experience. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for delaying the display of a progress meter during the loading of an electronic document. A user interface may be provided which includes a control surface and a browser window for displaying the electronic document. In the user interface, a request to load the electronic document in the browser window may be received. In response to the request, the loading of the requested electronic document may be initiated. A loading indicator associated with the requested electronic document may be displayed in the browser window. After a predetermined delay, the loading indicator may be replaced with a progress meter in the browser window. The progress meter may indicate a current loading percentage of the requested electronic document.

In another embodiment, the display of a progress meter during a long running operation in an electronic document may be delayed. A user interface may be provided which includes a browser window for displaying the electronic document. In the user interface, a request to initiate the long running operation in the electronic document may be received. In response to the request, the long running operation in the electronic document may be initiated. After a predetermined delay, a progress meter may be displayed in the browser window. The progress meter may indicate a current completion percentage of the long running operation in the electronic document.

In yet another embodiment, a method of switching from a web application to a client application during the loading of an electronic document may be provided. A user interface may be provided which includes a ribbon and a browser window of a web application for displaying the electronic document. In the user interface, a request to load the electronic document in the browser window of the web application may be received. In response to the request, the loading of the requested electronic document in the browser window of the web application may be initiated. A determination may be made that the requested electronic document is a long or complex document based on an elapsed time period for loading the requested electronic document reaching a predetermined threshold. Upon determining that the electronic document is a long or complex document, an alert bar may be displayed in the user interface. The alert bar may include a user control to open the requested electronic document in the client application instead of the browser window.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for delaying a progress meter during the loading of an electronic document, switching from a web application to a client application during the loading of an electronic document and delaying a progress meter during a long running operation in an electronic document, in accordance with various embodiments;

FIG. 2 is a block diagram illustrating a computing environment which may be utilized for delaying the display of a progress meter during the loading of an electronic document, switching from a web application to a client application during the loading of an electronic document and delaying the display of a progress meter during a long running operation in an electronic document, in accordance with various embodiments;

FIG. 3 is a computer screen display of a user interface which may be utilized for delaying the display of a progress meter during the loading of an electronic document, in accordance with an embodiment;

FIG. 4 is a computer screen display of a user interface which shows a progress meter at an early stage during the loading of an electronic document, in accordance with an embodiment;

FIG. 5 is a computer screen display of a user interface which shows a progress meter at a later stage during the loading of an electronic document, in accordance with an embodiment;

FIG. 6 is a computer screen display of a user interface which shows an alert bar following the loading of an electronic document, in accordance with an embodiment.

FIG. 7 is a flow diagram illustrating a routine for delaying the display of a progress meter during the loading of an electronic document, in accordance with an embodiment;

FIG. 8 is a flow diagram illustrating a routine for delaying the display of a progress meter during a long running operation in an electronic document, in accordance with an embodiment; and

FIG. 9 is a flow diagram illustrating a routine for switching from a web application to a client application during the loading of an electronic document, in accordance with an embodiment.

### DETAILED DESCRIPTION

Embodiments are provided for delaying the display of a progress meter during the loading of an electronic document. A user interface may be provided which includes a control surface and a browser window for displaying the electronic document. In the user interface, a request to load the electronic document in the browser window may be received. In response to the request, the loading of the requested electronic document may be initiated. A loading indicator associated with the requested electronic document may be displayed in the browser window. After a predetermined delay, the loading indicator may be replaced with a progress meter in the browser window. The progress meter may indicate a current loading percentage of the requested electronic document.

In another embodiment, the display of a progress meter during a long running operation in an electronic document may be delayed. A user interface may be provided which includes a browser window for displaying the electronic document. In the user interface, a request to initiate the long running operation in the electronic document may be received. In response to the request, the long running operation in the electronic document may be initiated. After a predetermined delay, a progress meter may be displayed in the browser window. The progress meter may indicate a current completion percentage of the long running operation in the electronic document.

In yet another embodiment, a method of switching from a web application to a client application during the loading of an electronic document may be provided. A user interface may be provided which includes a ribbon and a browser window of a web application for displaying the electronic document. In the user interface, a request to load the electronic document in the browser window of the web application may be received. In response to the request, the loading of the requested electronic document in the browser window of the web application may be initiated. A determination may be made that the requested electronic document is a long or complex document based on an elapsed time period for loading the requested electronic document reaching a predetermined threshold. Upon determining that the electronic document is a long or complex document, an alert bar may be displayed in the user interface. The alert bar may include a user control to open the requested electronic document in the client application instead of the browser window.

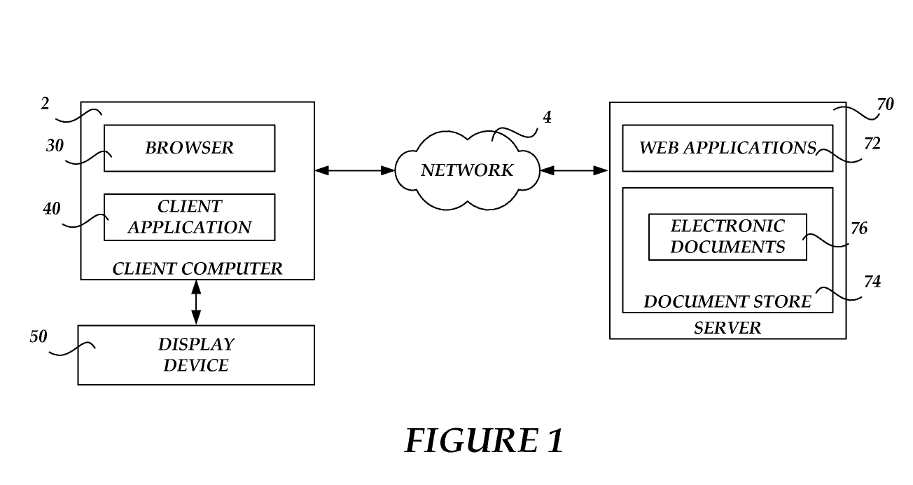

FIG. 1 is a block diagram illustrating a network architecture for delaying a progress meter during the loading of an electronic document, switching from a web application to a client application during the loading of an electronic document and delaying a progress meter during a long running operation in an electronic document, in accordance with various embodiments. The network architecture includes a client computer 2 in communication with a server computer 70 over a network 4 which may include a local network or a wide area network (e.g., the Internet). The client computer 2 may include a browser 30 and a client application 40. The client computer may also be in communication with a display device 50 for displaying content, such as electronic documents, in the browser 30 and/or the client application 40.

The browser 30 may comprise a web browser software application for retrieving, presenting, and traversing information resources provided by the server computer 70 (or other computers) over various networks which may include, without limitation, the Internet, private networks, or file systems. The information resources may include web pages, images, video, or other pieces of content. In accordance with an embodiment, the browser 30 may be configured to display a user interface generated by web applications 72 (executing on the server 70) for retrieving, viewing and editing electronic documents 76.

The client application 40 may comprise a rich client software application for retrieving, viewing, and editing the electronic documents 76 without use of the web applications 72. In accordance with an embodiment, the client application 40 may provide additional functionality not provided by the web applications 72 or, alternatively, provide a more optimized editing experience for certain large and/or and complex electronic documents. In accordance with an embodiment, the client application 40 may comprise one or more productivity application programs including, but not limited to, a word processing application programs, spreadsheet application programs, presentation application programs, and collaboration, file sharing and web publishing application programs which are used in the creation and editing of electronic documents. Illustrative productivity application programs may include, but are not limited to, the WORD, EXCEL, POWERPOINT, and SHAREPOINT application programs from Microsoft Corporation of Redmond, Wash. It should be appreciated, however, that productivity application programs from other manufacturers may also be utilized in accordance with the various embodiments described herein.

The server 70 may include the web applications 72 and a document store 74 which stores the electronic documents 76. In accordance with an embodiment, the web applications 72 may comprise web-based versions of one or more productivity application programs for generating and accessing electronic documents directly from anywhere within a web browser as well as to share files and collaborate with other users in an online environment. For example, the web applications 72 may include web-based versions of word processing application programs, spreadsheet application programs, presentation application programs, and collaboration, file sharing and web publishing application programs for generating word processing documents, spreadsheet documents and presentation electronic documents. In accordance with an embodiment, the web applications 72 may comprise a suite of productivity application programs such as the OFFICE WEB APPS suite of web-based productivity programs from Microsoft Corporation of Redmond, Wash. It should be appreciated, however, that web applications from other manufacturers may also be utilized in accordance with the various embodiments described herein.

The document store 74 may comprise a file storage and sharing service for storing electronic documents uploaded by client computer users for remote access by client computer based web browsers and/or rich client application programs. In accordance with an embodiment, the document store 74 may comprise the WINDOWS LIVE SKYDRIVE online file storage and sharing service from Microsoft Corporation of Redmond, Wash. It should be appreciated, however, that file storage and sharing services from other manufacturers may also be utilized in accordance with the various embodiments described herein.

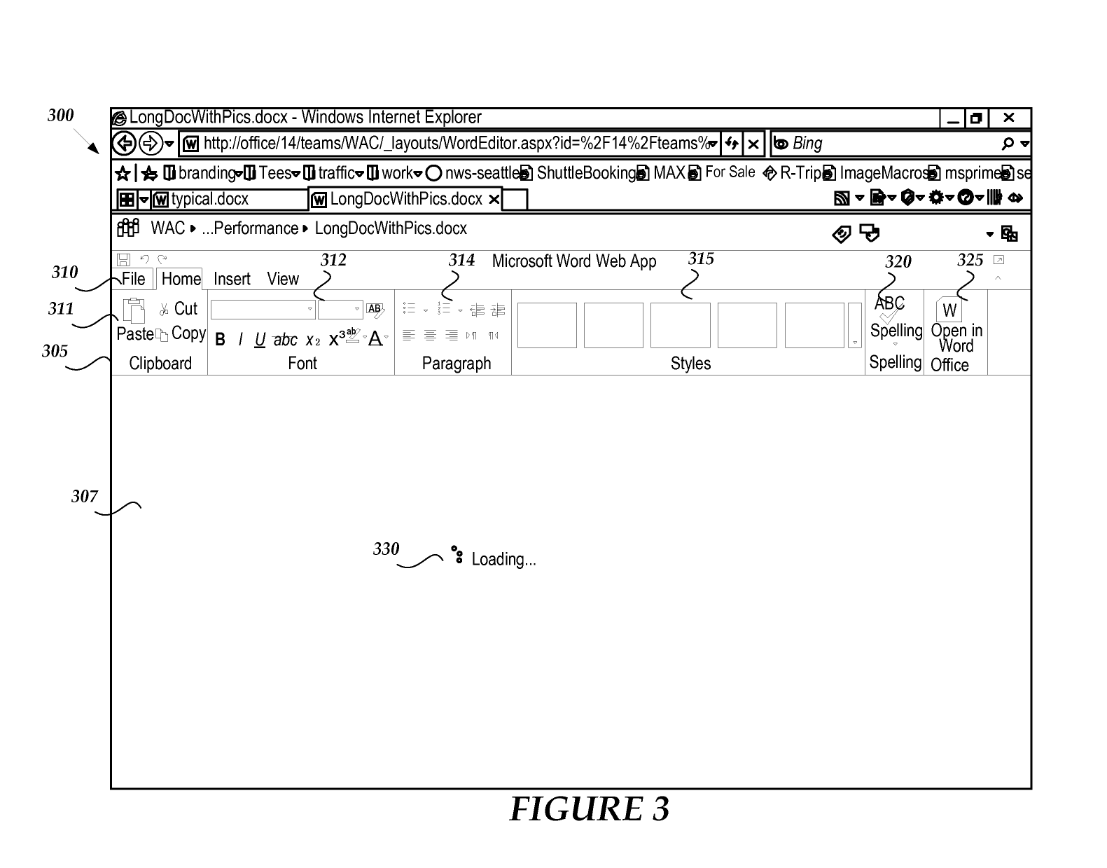

In accordance with an embodiment, the web applications 72 may be configured with program code to delay the generation of a progress meter during the loading of an electronic document in a user interface generated by the web applications 72. In accordance with another embodiment, the web applications 72 may further be configured to enable switching to a client application during the loading of an electronic document in a user interface. In accordance with yet another embodiment, the web applications 72 may be further configured to delay the generation of a progress meter during a long running operation in an electronic document in a user interface. The aforementioned embodiments will be described in greater detail with respect to FIGS. 3-9, below.

### Exemplary Operating Environment

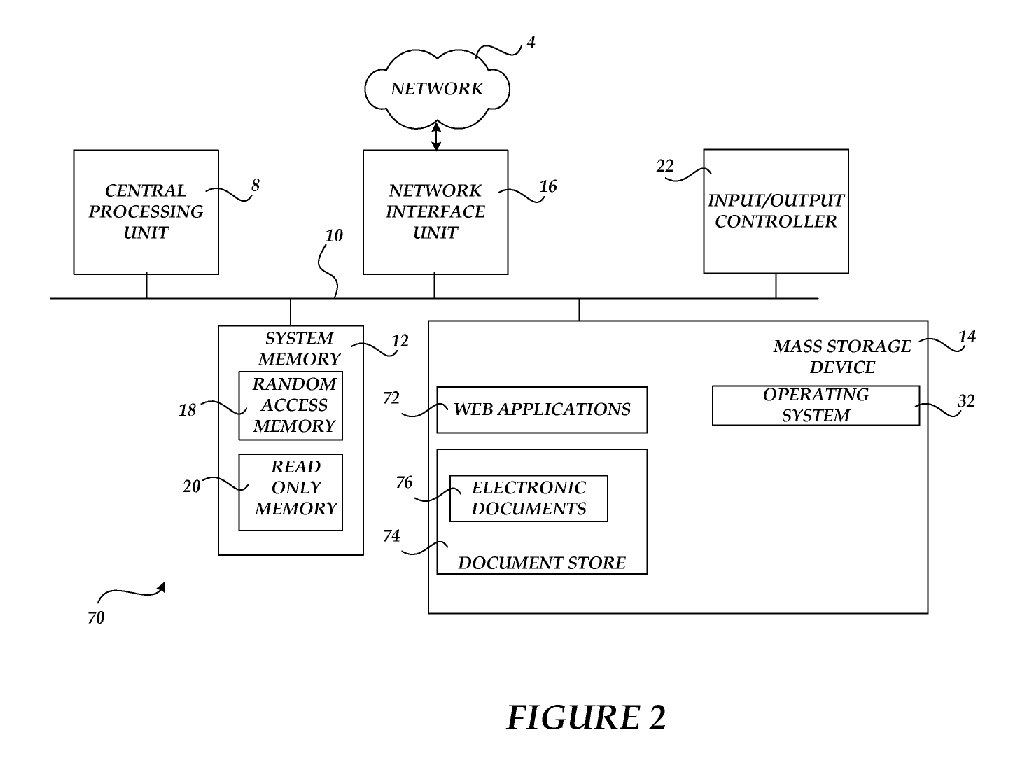

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows the server 70 which may include a general purpose desktop or other type of computer capable of executing one or more application programs. The server 70 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The server 70 further includes a mass storage device 14 for storing an operating system 32, the web applications 72, the document store 74 and the electronic documents 76. In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the server 70. The term computer-readable media as used herein may include computer storage media. Computer storage media may include volatile and nonvolatile, removable and non-removable media implemented in any method or technology for storage of information, such as computer readable instructions, data structures, program modules, or other data. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the server 70. Any such computer storage media may be part of the server 70.

The term computer-readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, the server 70 may operate in a networked environment using logical connections to remote computers through the network 4 which may comprise, for example, a local network or a wide area network (e.g., the Internet). The server 70 may connect to the network 4 through a network interface unit 16 connected to the bus 10. It should be appreciated that the network interface unit 16 may also be utilized to connect to other types of networks and remote computing systems. The server 70 may also include an input/output controller 22 for receiving and processing input from a number of input types, including a keyboard, mouse, pen, stylus, finger, and/or other means. Similarly, an input/output controller 22 may provide output to a display device, a printer, or other type of output device. Additionally, a touch screen can serve as an input and an output mechanism. It should be appreciated that the client computer 2, shown in FIG. 1, may include many of the conventional components shown and discussed above with respect to the server 70.

FIG. 3 is a computer screen display of a user interface 300 which may be utilized for delaying the display of a progress meter during the loading of an electronic document, in accordance with an embodiment. The user interface 300 may be generated by the web applications 72 on the server 70 and displayed in the browser 30 of the client computer 2. The user interface 300 may display a control surface, such as ribbon 305, and a browser window 307. It should be understood, that in accordance with various embodiments, the control surface may comprise the aforementioned ribbon 305. The control surface may alternatively comprise a series of menus or another user interface known to those skilled in the art.

The ribbon 305 may contain user controls for retrieving (i.e., loading), viewing and editing the electronic documents 76 which are displayed in the browser window 307. The user controls in the ribbon 305 may include a number of tabs, such File tab 310, galleries, such as Clipboard gallery 311, Font gallery 312, Paragraph gallery 314 and Styles gallery 315, and other user controls, such as Spelling user control 320 and Office user control 325. The Office user control 325 may be utilized to open a retrieved electronic document 76 in the client application 40. The browser window 307 may contain an editing surface into which the electronic documents 76 are loaded for viewing and editing. The user interface 300 also may display a Loading indicator 330 in the browser window 307. The Loading indicator 330 may be displayed in response to a request to load an electronic document 76.

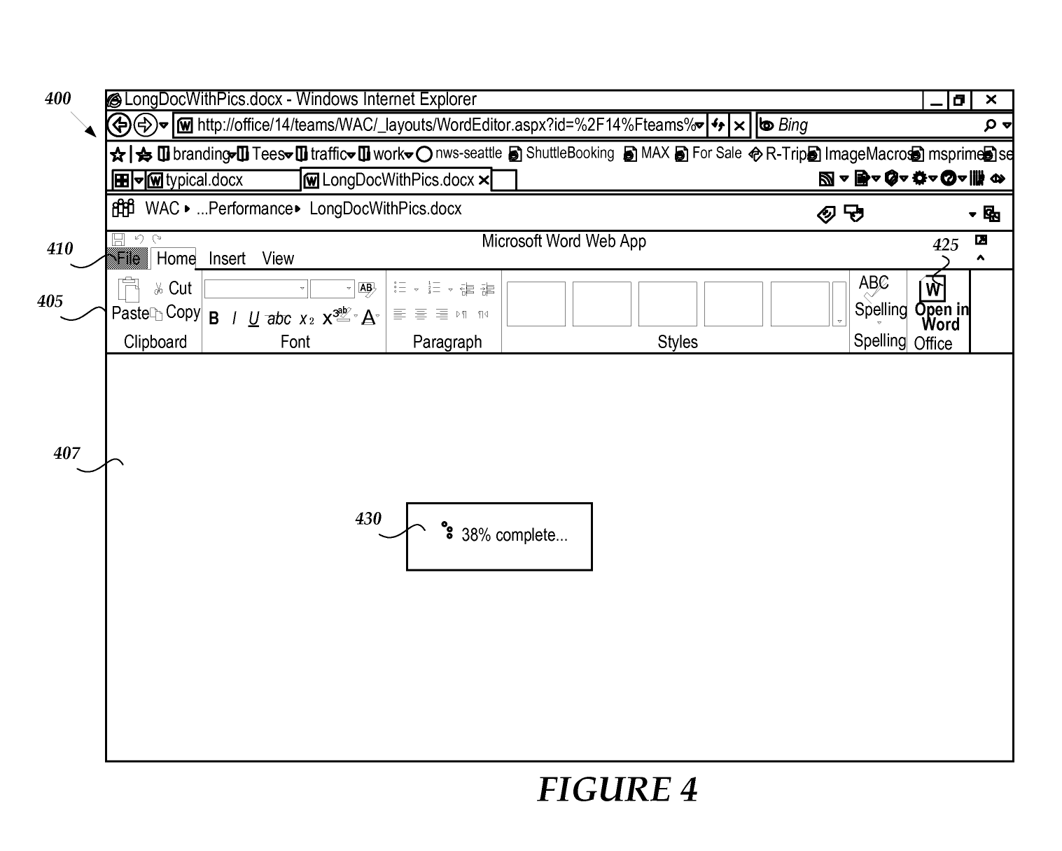

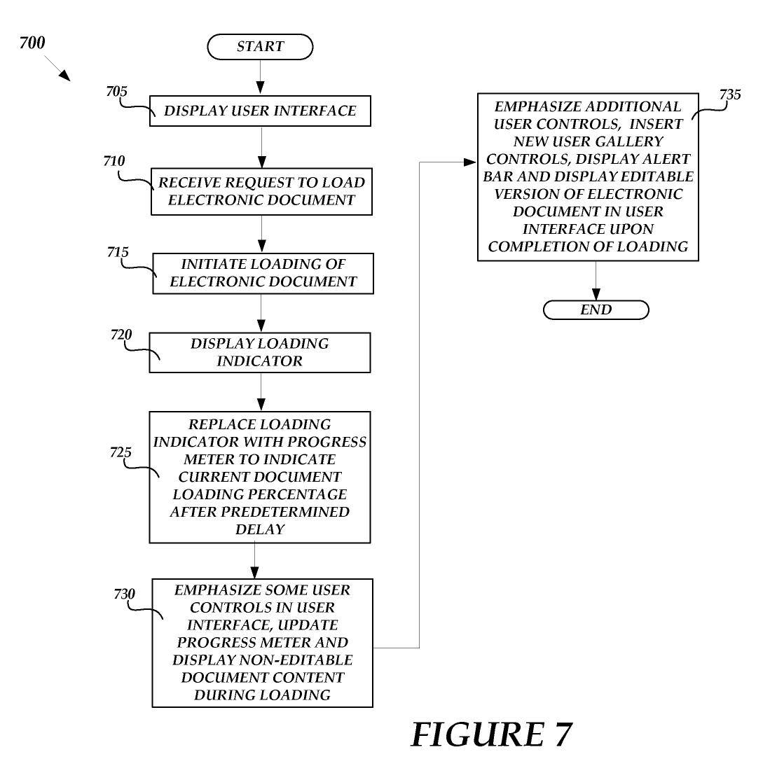

FIG. 4 is a computer screen display of a user interface 400 which shows a progress meter at an early stage during the loading of an electronic document, in accordance with an embodiment. The user interface 400 may be generated by the web applications 72 on the server 70 and displayed in the browser 30 of the client 2. The user interface 400 may display a ribbon 405 and a browser window 407. In accordance with the aforementioned embodiment, a progress meter 430 may be displayed in the browser window 407 indicating a current loading percentage of a previously requested electronic document 76. In particular, the progress meter 430 may be generated to replace a previously displayed loading indictor (such as the Loading indicator 330 of FIG. 3) after a predetermined delay. As will be discussed in greater detail with respect to FIG. 7, the predetermined delay may be based on a threshold. The ribbon 405 may display tabs and user controls which have been provided emphasis by the web applications 72 in order to provide a further indication of the loading status of a requested electronic document 76. For example, as shown in the ribbon 405, a File tab 410 and an Office user control 425 are emphasized (i.e., shaded and bolded) to indicate that an electronic document 76 is at an early stage (i.e., 38%) of being completely loaded for display in the browser window 407. It should be understood that additional or alternative types of emphasis (e.g., underlining, italicizing, blinking, etc.) to the aforementioned and/or other user controls during early stage of loading an electronic document 76 in the browser window 407, in accordance with various embodiments. It should be understood that, in accordance with various embodiments, the web applications 72 may be configured to provide emphasis to user and/or gallery controls in the ribbon 405 at various stages of the loading process of an electronic document 76 in the browser window 407. It should further be understood that the user controls in the ribbon 405 may be emphasized prior to or following the display of the progress meter 430.

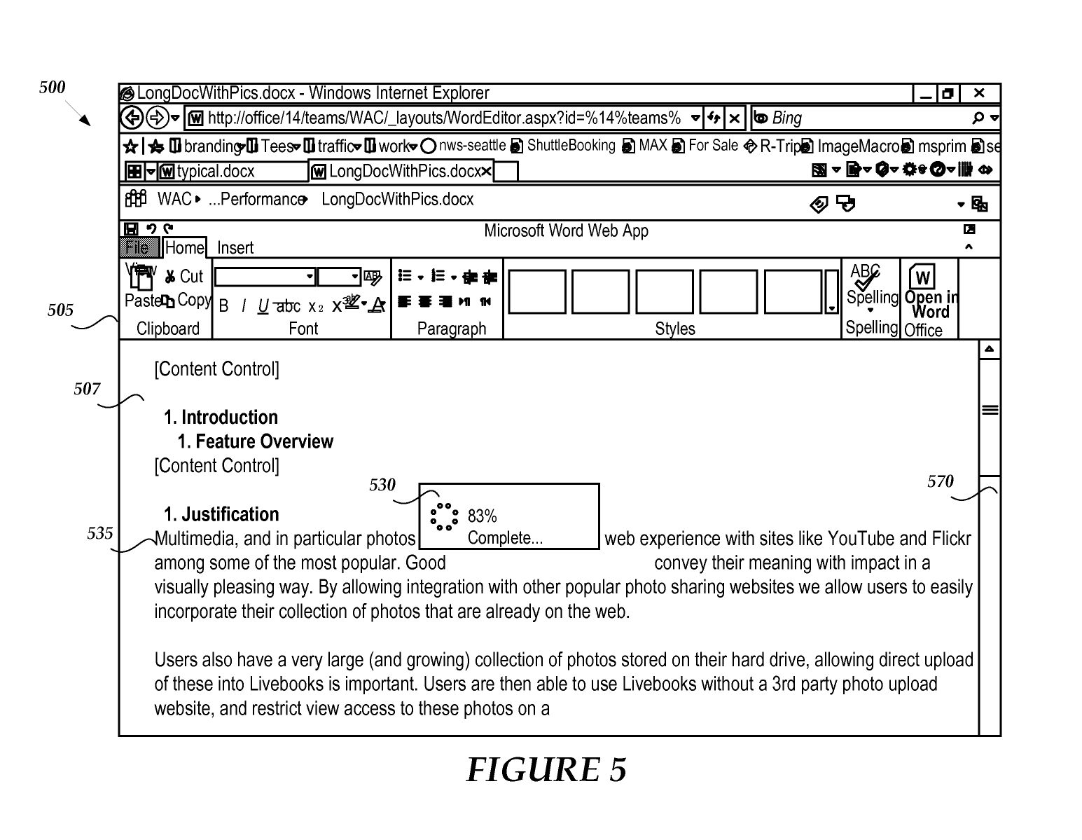

FIG. 5 is a computer screen display of a user interface 500 which shows a progress meter at a later stage during the loading of an electronic document, in accordance with an embodiment. The user interface 500 may be generated by the web applications 72 on the server 70 and displayed in the browser 30 of the client 2. The user interface 500 may display a ribbon 505 and a browser window 507. In accordance with the aforementioned embodiment, a progress meter 530 may be displayed in the browser window 507 indicating a current loading percentage of a previously requested electronic document 76. In particular, the progress meter 530 may be generated to replace a previously displayed loading indictor (such as the Loading indicator 330 of FIG. 3) after a predetermined delay or update a previously displayed progress meter (such as the progress meter 430 of FIG. 4). The ribbon 505 may display tabs and user controls which have been provided emphasis by the web applications 72 in order to provide a further indication of the loading status of a requested electronic document 76. For example, as shown in the ribbon 505, a File tab 510 and an Office user control 525 are emphasized (i.e., shaded and bolded) to indicate that an electronic file 76 is at a later stage (i.e., 83%) of being completely loaded for display in the browser window 507. As discussed above with respect to FIG. 4, the web applications 72 may be configured to provide additional or alternative types of emphasis (e.g., underlining, italicizing, blinking, etc.) to the aforementioned and/or other user controls during various stages of loading an electronic document 76 in the browser window 407, in accordance with various embodiments. The user interface 500 may further display non-editable content comprising a portion of an electronic document 76 which is currently being loaded in the browser window 507. The displayed non-editable content may indicate that the loading of an electronic document 76 in the browser window 507 is nearing completion). The user interface 500 may further display a scroll bar 570 indicative of the partially loaded status of an electronic document 76 in the browser window 507.

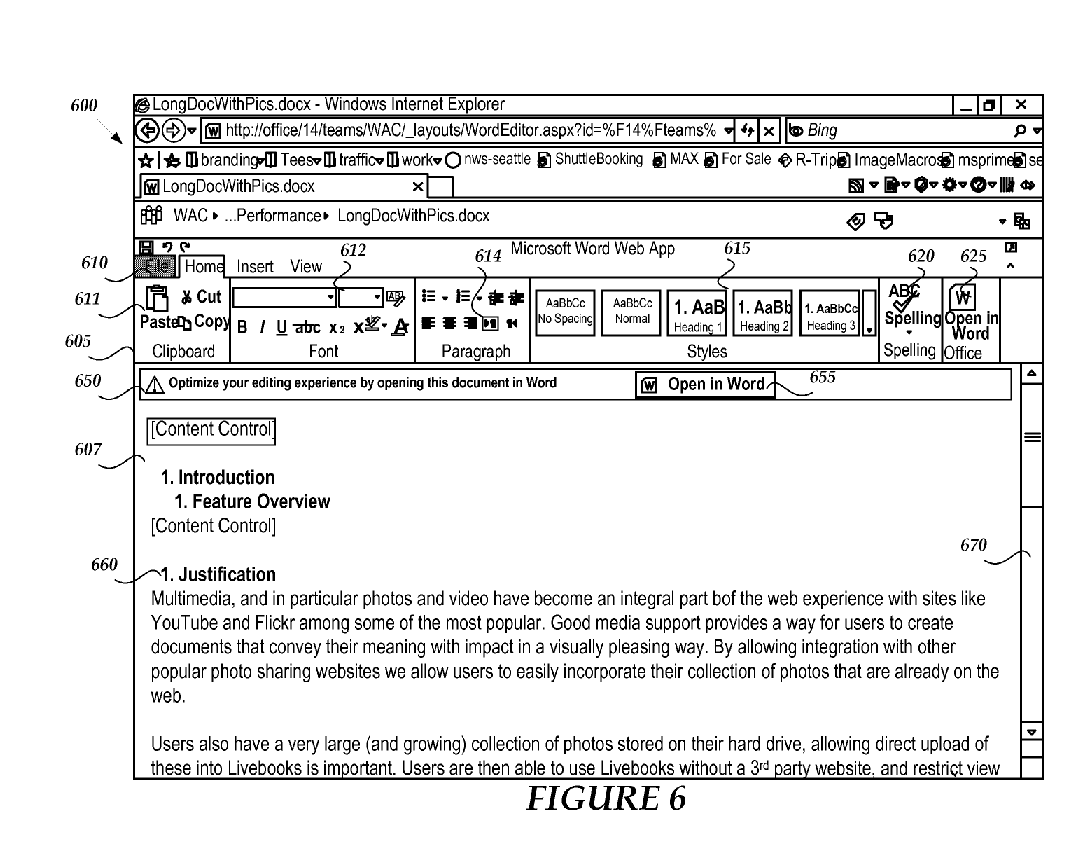

FIG. 6 is a computer screen display of a user interface 600 which shows an alert bar following the loading of an electronic document, in accordance with an embodiment. The user interface 600 may be generated by the web applications 72 on the server 70 and displayed in the browser 30 of the client 2. The user interface 600 may display an alert bar (i.e., a business bar) 650. The alert bar 650 which may comprise user control 655 for opening an electronic document 76 in the client application 40. In accordance with an embodiment, the alert bar 650 may be utilized to notify a user of an optimized editing experience associated with an electronic document 76 which may be provided by the client application 40. In particular, the client application 40 may provide additional functionality not provided by the web applications 72 or, alternatively, provide a more optimized editing experience for certain large and/or complex electronic documents. The user interface 600 may also display a ribbon 605 and a browser window 607. In accordance with the present embodiment, an electronic document 76 has been completely loaded in the browser window 607. The browser window 607 may display editable content 660 comprising a completely loaded electronic document 76. The user interface 600 may also display a scroll bar 670 indicative of the completely loaded status of an electronic document 76 in the browser window 607. The ribbon 605 may further display additional tabs and user controls which have been provided emphasis by the web applications 72 in order to provide a further indication of the completely loaded status of an electronic document 76. For example, once an electronic document 76 has been completely loaded in the browser window 607, emphasis may be provided to the entire ribbon 605, including the File tab 610 (which may be shaded), the Clipboard gallery 611 (which may be bolded), the Font gallery 612 (which may be bolded), the Paragraph gallery 614, the Spelling user control 620 and the Office user control 625. Furthermore, the Styles gallery 615, which may have previously been blank during the document loading process (for example, see FIG. 3 which shows a blank Styles gallery 315), may be drawn in with additional user controls which may be used for editing a completely loaded electronic document 76.

FIG. 7 is a flow diagram illustrating a routine 700 for delaying the display of a progress meter during the loading of an electronic document, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 7-9 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 700 begins at operation 705, where the web applications 72 executing on the server 70 display a user interface in the browser 30 of the client computer 2. In particular, a user of the client computer 2 may utilize the browser 30 to communicate with the server 70 over the network 4 to access and execute the web applications 72. An illustrative user interface which may be displayed in the browser 30 is shown in FIG. 3 (discussed above).

From operation 705, the routine 700 continues to operation 710, where the web applications 72 receive a request to load an electronic document 76 on the client computer 2. For example, a user of the client computer 2 may utilize the File tab 310 in the user interface 300 of FIG. 3 to select an electronic document 76 in the document store 74 for viewing and editing in the browser 30.

From operation 710, the routine 700 continues to operation 715, where the web applications 72 may initiate the loading of an electronic document 76 in the browser 30 of the client computer 2.

From operation 715, the routine 700 continues to operation 720, where the web applications 72 may display a loading indicator for an electronic document 76 in the browser 30 of the client computer 2. An illustrative loading indicator is shown in the user interface 300 of FIG. 3 (discussed above).

From operation 720, the routine 700 continues to operation 725, where the web applications 72 may replace the loading indicator with a progress meter to indicate a current loading percentage for an electronic document 76, after a predetermined delay. In particular, the web applications 72 may be configured to determine whether a delay threshold has been reached and whether a current loading percentage of an electronic document 76 is greater than zero, prior to replacing the loading indicator with the progress meter. An illustrative progress meter is shown in the user interfaces 400 and 500 in FIGS. 4 and 5 (discussed above). It should be understood that, in accordance with an embodiment, the delay threshold is measured from when the web applications 72 are initialized in the browser 30 on the client computer 2. Thus, any network transfer time between the server 70 and the client computer 2 is not accounted for. For example, the web applications 72 may be configured to always wait six seconds (i.e., the predetermined elapsed time period) prior to replacing the loading indicator with the progress meter. Thus, if six seconds have elapsed and the current loading percentage of an electronic document 76 is greater than zero, then the progress meter will be displayed. Otherwise, the display of the progress meter will continue to be delayed. In accordance with an embodiment, the current loading percentage may be determined by determining a quantity of objects or nodes for representing an electronic document 76 in the browser 30, estimating, based on the quantity of objects, a load time for rendering the electronic document in the browser 30, parsing the objects for assembly into a graph representation of the electronic document, and determining the current loading percentage based on the quantity of objects that have been successfully parsed. It should be understood that estimating a load time based on the quantity of objects may also include taking into a complexity which may be associated with each object. In particular, more complex objects may take more time to render than less complex objects because of memory requirements. For example, one or more spreadsheet table cells may require more memory to render than a paragraph. In accordance with an embodiment, complexity may be represented by a predetermined cost factor which may be assigned to different object types. Thus, a paragraph object containing unformatted text in an electronic document may have a cost factor of 1, a paragraph object containing formatted text may have a cost factor of 2, a spreadsheet table cell may have a cost factor of 3 and a picture or image may have a cost factor of 4.

From operation 725, the routine 700 continues to operation 730, where the web applications 72 may emphasize some user controls (which may be contained in a user interface ribbon), display non-editable content, and update the progress meter in a user interface generated by the web applications 72 during the continued loading of an electronic document 76. Illustrative user interfaces (i.e., user interfaces 400 and 500) displaying the aforementioned features are shown in FIGS. 4 and 5 (discussed above). It should be appreciated that the web applications 72 may update the progress meter as more of an electronic document 76 is loaded.

From operation 730, the routine 700 continues to operation 735, where the web applications 72 may emphasize additional user controls and insert new user gallery controls (the user and gallery controls may be contained in a user interface ribbon), display an alert bar and display an editable version of an electronic document 76 in a user interface generated by the web applications 72 upon the completion of loading of an electronic document 76. An illustrative user interface (i.e., user interface 600) displaying the aforementioned feature is shown in FIG. 6. As discussed above with respect to FIG. 6, the alert bar may comprise a user control for opening an electronic document 76 in the client application 40. In accordance with an embodiment, the alert bar may be utilized to notify a user of an optimized editing experience associated with an electronic document 76 which may be provided by the client application 40. In particular, the client application 40 may provide additional functionality not provided by the web applications 72 or, alternatively, provide a more optimized editing experience for certain large and/or complex electronic documents. From operation 730, the routine 700 then ends.

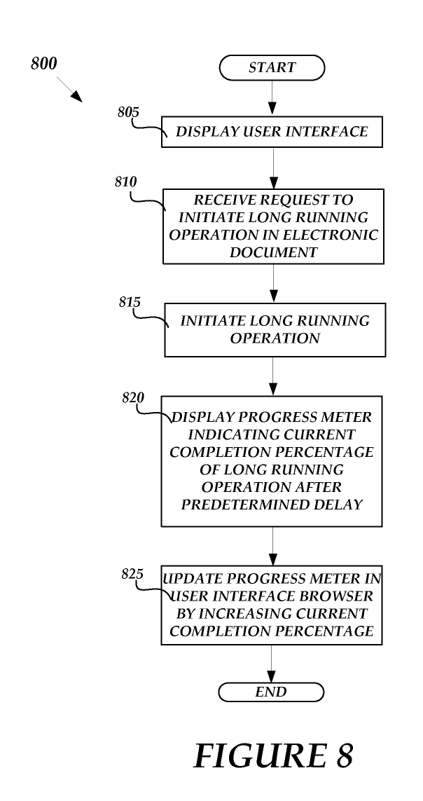

FIG. 8 is a flow diagram illustrating a routine 800 for switching from a web application to a client application during the loading of an electronic document, in accordance with an embodiment. The routine 800 begins at operation 805, where the web applications 72 executing on the server 70 display a user interface in the browser 30 of the client computer 2. In particular, a user of the client computer 2 may utilize the browser 30 to communicate with the server 70 over the network 4 to access and execute the web applications 72. An illustrative user interface which may be displayed in the browser 30 is shown in FIG. 3 (discussed above).

From operation 805, the routine 800 continues to operation 810, where the web applications 72 receive a request to initiate a long running operation in an electronic document 76 currently displayed in a user interface in the browser 30 of the client computer 2. For example, a user of the client computer 2, who is currently editing a displayed electronic document 76, may wish to perform a global formatting change on electronic document text or perform a complex mathematical operation on electronic document data. Either of the aforementioned examples may comprise a long running operation in accordance with the various embodiments described herein. It should be appreciated that the aforementioned operations may place a significant demand on computer resources (e.g., processor and memory resources) and may further take longer than to perform than other, less complex operations.

From operation 810, the routine 800 continues to operation 815, where the web applications 72 may initiate a long running operation in an electronic document 76 in the browser 30 of the client computer 2.

From operation 815, the routine 800 continues to operation 820, where the web applications 72 may display a progress meter to indicate a current completion percentage for the long running operation initiated at operation 810, after a predetermined delay. In particular, the web applications 72 may be configured to determine whether a delay threshold has been reached prior to displaying the progress meter. In accordance with an embodiment, the progress meter may be displayed when two conditions have been met. The first condition is that a predetermined time threshold has to be exceeded. The second condition is that the current completion percentage for the long running operation (i.e., the number of objects parsed in the electronic document for completing the long running operation) must exceed zero percent.

From operation 820, the routine 800 continues to operation 825, where the web applications 72 may update the progress meter in a user interface generated by the web applications 72 by increasing the current completion percentage of the long running operation. From operation 825, the routine 800 then ends.

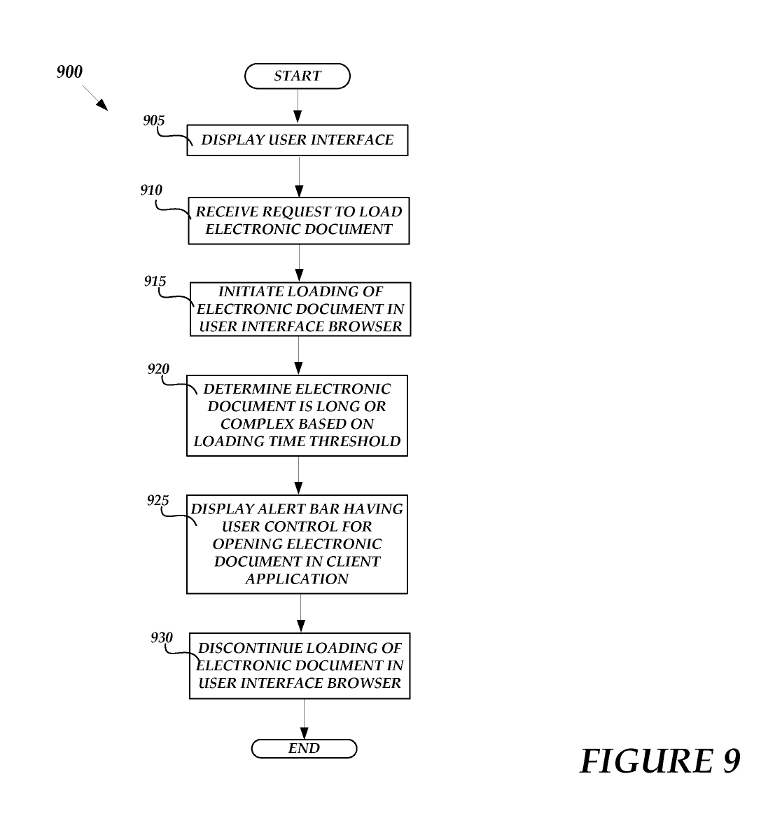

FIG. 9 is a flow diagram illustrating a routine 900 for switching from a web application to a client application during the loading of an electronic document, in accordance with an embodiment. The routine 900 begins at operation 905, where the web applications 72 executing on the server 70 display a user interface in the browser 30 of the client computer 2. In particular, a user of the client computer 2 may utilize the browser 30 to communicate with the server 70 over the network 4 to access and execute the web applications 72. An illustrative user interface which may be displayed in the browser 30 is shown in FIG. 3 (discussed above).

From operation 905, the routine 900 continues to operation 910, where the web applications 72 receive a request to load an electronic document 76 on the client computer 2. For example, a user of the client computer 2 may utilize the File tab 310 in the user interface 300 of FIG. 3 to select an electronic document 76 in the document store 74 for viewing and editing in the browser 30.

From operation 910, the routine 900 continues to operation 915, where the web applications 72 may initiate the loading of an electronic document 76 in the browser 30 of the client computer 2.

From operation 915, the routine 900 continues to operation 920, where the web applications 72 may determine an electronic document 76 currently being loaded is long or complex based on a predetermined loading time threshold. It should be understood that a long or complex document may comprise an electronic document having either a large file size, a file having complex contents (e.g., the electronic document may contain tables, images, formatted text, etc.), or both In accordance with an embodiment, a timer may be initiated during the loading of an electronic document 76. In particular, a timer may be started at the point when a document map representing an electronic document 76 begins being built into the memory of the client computer 2 and thus does not include any network transfer time. The electronic document 76 is then determined to be long or complex when the timer reaches the predetermined loading time threshold and the electronic document has not been fully rendered in user interface browser window generated by the web applications 72. For example, the web applications 72 may determined that an electronic document 76 currently being loaded is long and/or complex once the timer reaches ten seconds and the electronic document has still not finished rendering in the user interface browser window.

From operation 920, the routine 900 continues to operation 925, where the web applications 72 may display an alert bar having a user control for opening an electronic document 76 in the client application 40. In particular, upon determining that an electronic document is long and/or complex, the web applications may display an alert bar in a user interface generated by the web applications 72. An illustrative user interface displaying an alert bar is shown in FIG. 6 (discussed above). In accordance with an embodiment, the alert bar may display a message to a user of the client computer 2 that user editing experience may be optimized by selecting the user control to open the electronic document currently being loaded (i.e., the electronic document is still being rendered) in the client application 40 instead of in the user interface generated by the web applications 72.

From operation 925, the routine 900 continues to operation 930, where the web applications 72, upon receiving a selection of the user control in the alert bar, may discontinue the loading of an electronic document 76 in the user interface and initiate the loading of the electronic document 76 in the client application 40. From operation 930, the routine 900 then ends.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method for delaying the display of a progress meter during the loading of an electronic document, comprising:
displaying, by a computer, a user interface comprising a control surface and a browser window for displaying the electronic document;
receiving, by the computer, a request to load the electronic document in the browser window;
in response to receiving the request:
initiating, by the computer, loading of the requested electronic document; and
displaying, by the computer, a loading indicator for with the requested electronic document, in the browser window; and
replacing, by the computer, after a predetermined delay, the loading indicator with a progress meter in the browser window, the progress meter indicating a current loading percentage of the requested electronic document.

2. The method of claim 1, further comprising updating the progress meter in the browser window by increasing the current loading percentage during the loading of the requested electronic document.

3. The method of claim 1, further comprising:
emphasizing at least one user control in the control surface during the loading of the requested electronic document to indicate that the requested electronic document is being loaded; and
displaying non-editable content comprising at least a portion of the requested electronic document during the loading of the requested electronic document.

4. The method of claim 1, wherein receiving, by the computer, a request to load the electronic document in the browser window comprises receiving a request to load a web application document in the browser window.

5. The method of claim 1, wherein displaying, by a computer, a user interface comprising a control surface comprises displaying a ribbon the ribbon comprising a first row comprising a plurality of tabs and a second row comprising a gallery, wherein the plurality of tabs and the gallery comprises a plurality of user controls for viewing and editing the electronic document.

6. The method of claim 1, wherein replacing, by the computer, after a predetermined delay, the loading indicator with a progress meter in the browser window indicating a current loading percentage of the requested electronic document comprises:
determining that a predetermined time threshold has been exceeded; and
determining that the current loading percentage of the requested electronic document is greater than zero.

7. The method of claim 1, wherein replacing, by the computer, after a predetermined delay, the loading indicator with a progress meter in the browser window indicating a current loading percentage of the requested electronic document comprises determining the current loading percentage, wherein determining the current loading percentage comprises:
determining a quantity of objects for representing the requested electronic document in the browser window;
estimating a load time for the requested electronic document based on the quantity of objects;
parsing the objects for assembly into a graph representation of the electronic document; and
determining the current loading percentage based on the quantity of objects that have been successfully parsed.

8. The method of claim 3, further comprising emphasizing a plurality of additional user controls in the control surface upon completion of the loading of the requested electronic document.

9. The method of claim 8, further comprising inserting new user controls in a gallery portion of the control surface upon completion of the loading of the requested electronic document.

10. The method of claim 1, further comprising:
displaying an alert bar in the user interface upon completion of the loading of the requested electronic document; and
displaying an editable version of the requested electronic document in the browser window.

11. A computer-implemented method for delaying a progress meter during a long running operation in an electronic document, comprising:
displaying, by a computer, a user interface comprising a browser window for displaying the electronic document;
receiving, by the computer, a request to initiate the long running operation in the electronic document;
in response to receiving the request:
initiating, by the computer, the long running operation in the electronic document; and
displaying, by the computer, after a predetermined delay, a progress meter in the browser window, the progress meter indicating a current completion percentage of the long running operation in the electronic document.

12. The method of claim 11, further comprising updating the progress meter in the browser window by increasing the current completion percentage the long running operation in the electronic document.

13. The method of claim 11, wherein receiving, by the computer, a request to initiate the long running operation in the electronic document in response to receiving the request comprises receiving a request to initiate an editing operation in the electronic document.

14. The method of claim 11, wherein receiving, by the computer, a request to initiate the long running operation in the electronic document in response to receiving the request comprises receiving a request to initiate a mathematical operation in the electronic document.

15. The method of claim 11, wherein displaying, by the computer, after a predetermined delay, a progress meter in the browser window, the progress meter indicating a current completion percentage of the long running operation in the electronic document comprises:
determining that a predetermined time threshold has been exceeded; and
determining that the current completion percentage of the long running operation in the electronic document is greater than zero.

16. The method of claim 11, wherein displaying, by the computer, after a predetermined delay, a progress meter in the browser window, the progress meter indicating a current completion percentage of the long running operation in the electronic document comprises:
parsing a quantity of objects determined for completing the long running operation; and
determining the current completion percentage based on the quantity of objects that have been successfully parsed.

17. A computer-implemented method for switching from a web application to a client application during the loading of an electronic document, comprising:
displaying, by a computer, a user interface comprising a ribbon and a browser window of a web application for displaying the electronic document;
receiving, by the computer, a request to load the electronic document in the browser window of the web application;
in response to receiving the request:
initiating, by the computer, loading of the requested electronic document in the browser window of the web application;
determining, by the computer, based on a loading time associated with the requested electronic document reaching a predetermined threshold, that the requested electronic document is at least one of a long and a complex electronic document; and
displaying an alert bar in the user interface, the alert bar comprising a user control to open the requested electronic document in the client application, upon determining that the requested electronic document is at least one of a long and a complex electronic document.

18. The method of claim 17, further comprising discontinuing the loading of the requested electronic document in the browser window of the web application, upon determining that the requested electronic document is at least one of a long and a complex electronic document.

19. The method of claim 17, further comprising displaying a user control in the ribbon of the web application for opening the requested electronic document in the client application.

20. The method of claim 17, wherein determining, by the computer, based on a loading time associated with the requested electronic document reaching a predetermined threshold, that the requested electronic document is at least one of a long and a complex electronic document comprises:
initiating a timer during the loading of the requested electronic document in the browser window of the web application; and
determining that the requested electronic document is at least one of a long and a complex document when the timer reaches the predetermined threshold and the requested electronic document has not been fully rendered in the browser window of the web application.
